(19) United States
(12) Patent Application Publication
(10) Pub. No.: US 2010/0051885 A1
(43) Pub. Date: Mar. 4, 2010

(54) Lifting Method and Apparatus

(76) Inventors: Mark E. Davis, Haw River, NC (US); Charles Davis, Pittsboro, NC (US)

Correspondence Address: COATS & BENNETT, PLLC, 1400 Crescent Green, Suite 300, Cary, NC, 27518, US

(21) Appl. No.: 12/550,994

(22) Filed: Aug. 31, 2009

Related U.S. Application Data
(60) Provisional application No. 61/093,545, filed on Sep. 2, 2008.

(51) Int. Cl. B66F 7/14

(52) U.S. Cl. 254/92; 254/98

(57) ABSTRACT

A lifting apparatus and associated lifting method provide for safe and quick lifting of equipment, such as for pallet removal. The lifting apparatus comprises a lifting rail that incorporates a spindle assembly at each end. Each spindle assembly moves on a threaded rod, vertically retained in a lift stand. Rotating the spindle assembly causes it to move up or down on the threaded rod, depending on the direction of rotation. In one embodiment, one of the spindle assemblies includes a drive input that interfaces with an external driver that provides motive force for rotating the spindle assembly. A chain, for example, interconnects the driven spindle assembly with the other spindle assembly, such that both spindle assemblies rotate together, and the lifting rail therefore remains level as it moves up and down. A pair of lifting apparatuses may be placed along opposite sides of a given machine and operated together.

### RELATED APPLICATIONS

The present application claims priority from the U.S. provisional patent application entitled “Lifting Method and Apparatus,” as filed on 2 Sep. 2008 and assigned App. No. 61/093,545, and which is explicitly incorporated herein by reference.

### FIELD OF THE INVENTION

The present invention generally relates to lifting items, such as palletized equipment, and particularly relates to a lifting method and apparatus.

### BACKGROUND

Lifting palletized equipment and other potentially heavy, bulky items safely presents a number of challenges. Beyond the risk of injury or death, improper lifting risks damaging the equipment or premises. Further, without a lightweight, easy-to-use, and versatile lifting apparatus, moving, delivering, and installing equipment takes longer and requires more personnel than it should. However, the range of equipment types at issue and the frequent use of pallets to transport such equipment greatly complicate the task of designing suitable lifting equipment.

### SUMMARY

A lifting apparatus and associated lifting method provide for safe and quick lifting of equipment, and provide particular advantages for lifting palletized equipment up, for easy pallet removal. In one or more embodiments, the lifting apparatus comprises a lifting rail, which incorporates a spindle assembly at each of its ends. In turn, each spindle assembly moves on a threaded rod, vertically retained in a lift stand. In other words, each end of the lifting rail is supported on the threaded rod by the included spindle assembly.

The bottom of each spindle assembly includes a recess or other opening that is configured to engage a hex nut or the like that is threaded onto the threaded rod on which the spindle assembly is mounted. In this manner, rotating the spindle assembly also rotates the hex nut, thereby causing the spindle assembly to move up or down on the threaded rod, depending on the direction of rotation. In one embodiment, one of the spindle assemblies includes a drive input that interfaces with an electric drill—e.g., a clutched electric drill driver—or other external driver that provides motive force for rotating the spindle assembly. The driven spindle assembly interconnects with the spindle assembly at the other end of the lifting rail, e.g., by belt, chain, gear, such that both spindle assemblies rotate together, and the lifting rail therefore remains level as it moves up and down.

A pair of such lifting apparatus may be placed along opposite sides of a given machine. Advantageously, the spindle assemblies move freely along the threaded rods, thus allowing for easy removal of the lifting rails from the rods, and the threaded rods are quickly and easily removed from their respective lifting stands. These features allow an operator to quickly position one or more lifting rails under a machine to be lifted, insert the threaded rods through the spindle assemblies at the ends of the lifting rail(s), and then set the threaded rods into their respective lift stands.

However, the present invention is not limited to the above summary of features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a perspective view of one embodiment of a lifting apparatus as taught herein.

FIG. 2 is a plan view, illustrating a pair of lifting apparatuses in position for lifting an item.

FIG. 3 is a perspective view, illustrating the lifting apparatus of FIG. 1 in more detail, including a cutaway view of a spindle assembly at one end of a lifting rail included in the lifting apparatus.

FIG. 4 is a perspective view of one embodiment of a lifting rail, for use in a lifting apparatus as taught herein.

FIGS. 5 and 6 are perspective views of one embodiment of master and slave spindle assemblies, for use in a lifting rail.

FIG. 7 is an exploded view of one embodiment of a spindle assembly for use in a lifting rail.

FIG. 8 is a cutaway view of one end of a lifting rail, and it illustrates one embodiment of a spindle assembly as installed in the lifting rail.

FIGS. 9 and 10 are bottom and top views, respectively, of the end of the lifting rail depicted in FIG. 8.

FIG. 11 is a side view of one or more lifting apparatuses, as might be positioned relative to an item to be lifted in a pre-lifting phase of a lifting method.

FIG. 12 is a plan view of the item and lifting apparatuses introduced in FIG. 11, and depicts the pre-lift positioning of lifting rails and respective lift stands relative to the item to be lifted.

FIG. 13 is a side view of the lifting apparatuses and item to be lifted, as introduced in FIG. 11, but shown in a ready configuration for lifting.

FIG. 14 is a side view of the lifting apparatuses and item to be lifted, as introduced in FIG. 11, but shown with the item in a lifted position.

### DETAILED DESCRIPTION

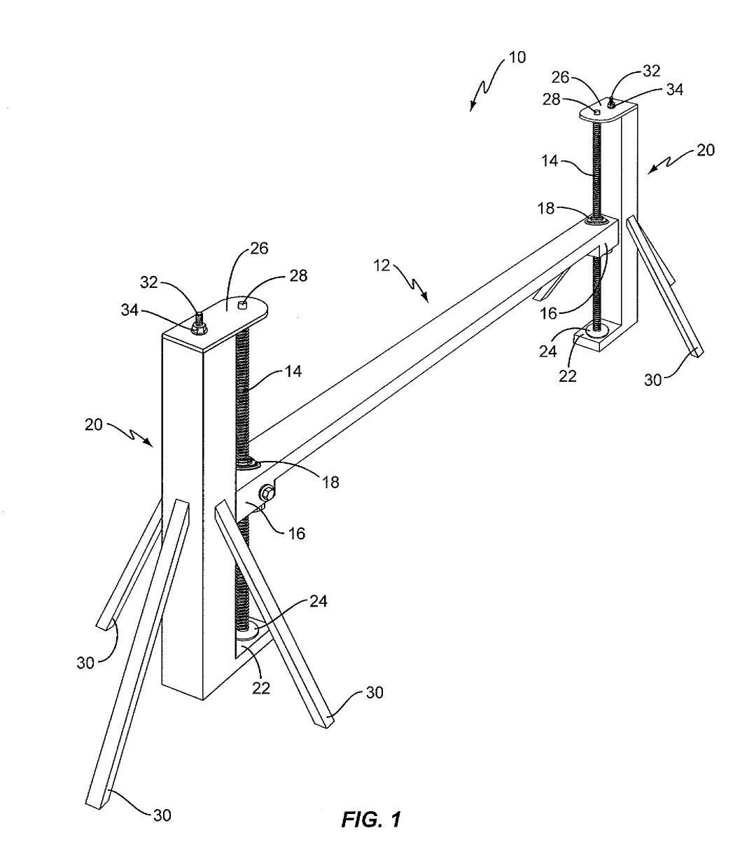

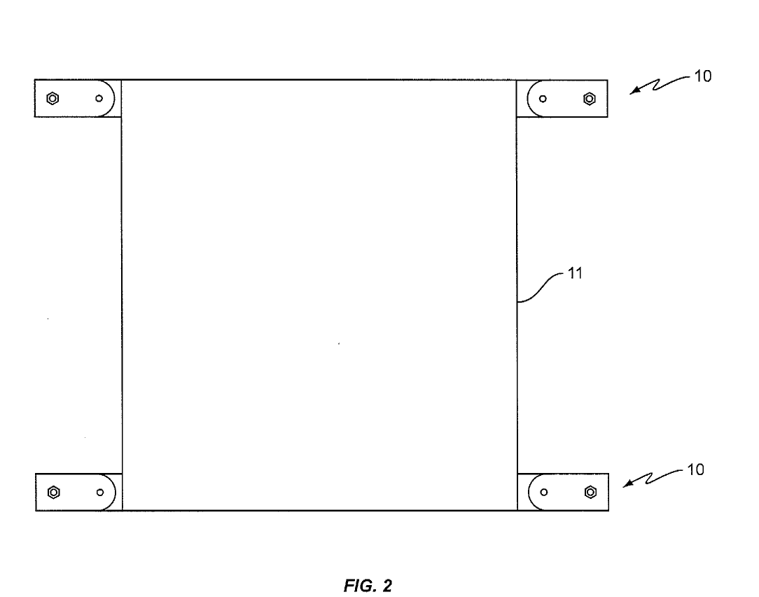

FIG. 1 is a perspective view of one embodiment of a lifting apparatus 10. As a non-limiting example, FIG. 2 provides a plan view, illustrating by way of non-limiting example that a pair of these lifting apparatuses 10 can be positioned along opposite sides of an item 11 and advantageously used to raise the item 11 temporarily. Such use of the lifting apparatus 10 is particularly advantageous for lifting palletized equipment up from an underlying pallet, thereby allowing easy pallet removal.

Now returning to FIG. 1 for a better understanding of the lifting apparatus 10, one sees that the illustrated embodiment comprises a lifting rail 12 that is supported at each end by threaded rods 14. In particular, each end 16 of the lifting rail 12 is “boxed” or otherwise formed to retain a spindle assembly 18 (only partially visible in the diagram) that moves up and down on its corresponding threaded rod 14. In turn, each threaded rod 14 is supported by a lift stand 20, which maintains the vertical orientation of the threaded rod 14 and prevents its rotation during operation of lifting apparatus 10. Note that each lift stand 20 may include one or more supports 30, which allow the lift stand 20 to be free standing in some embodiments, and which enhance stability of the lift stand 20 under loading.

With reference to a given one of the lift stands 20, a base plate 22 retains the bottom end 24 of the threaded rod 14, while a top plate 26 retains the top end 28 of the threaded rod 14. The top plate 26 is removable, or is otherwise configured to disengage from the top end 28 of the threaded rod 14, which allows the lifting rail 12 to be lifted off of the threaded rods 14, and allows the threaded rods 14 to be removed from the lift stands 20. This ease of disassembly facilitates transport of the lifting apparatus 10 and, as will be seen in later drawings, greatly aids placement and setup of the lifting apparatus 10 with respect to the item to be lifted.

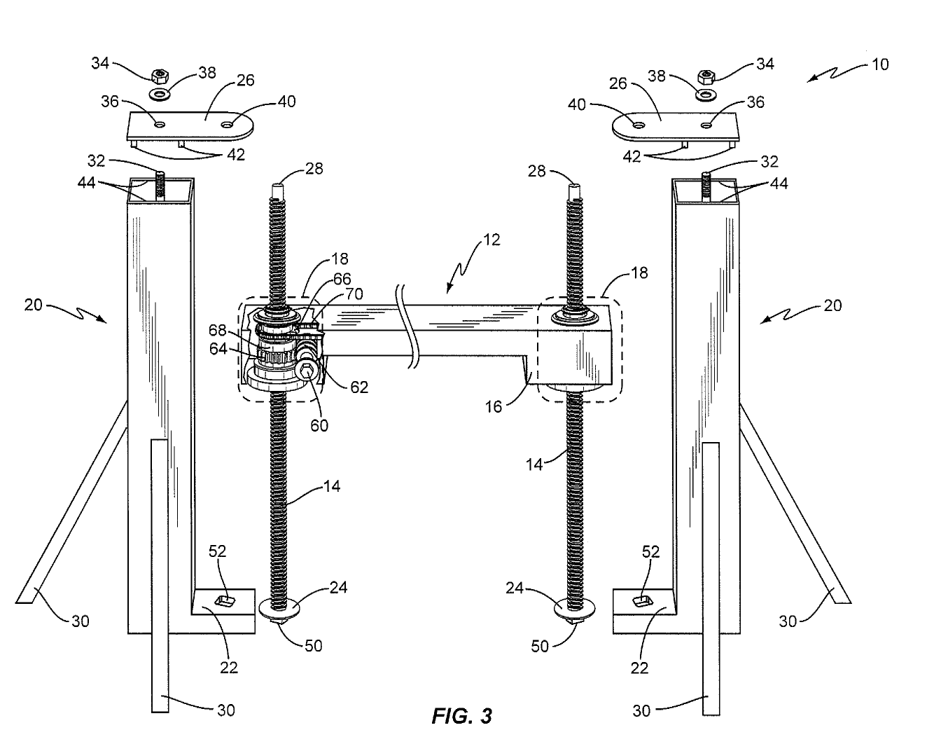

In the illustrated embodiment, the top plate 26 is removably retained by the lift stand 20 via the use of threaded fasteners. In particular, the lift stand 20 includes a top plate bolt 32 that passes through the top plate 26, and a retaining nut 34 secures the top plate 26 in place. FIG. 3 illustrates this arrangement in more detail, and also provides further spindle assembly details.

In FIG. 3, one sees the top plates 26 removed from their respective lift stands 20, such that one sees the top plate bolt 32 projecting upward from the lift stand 20 and a corresponding opening 36 in the top plate 26 that allows the top plate bolt 32 to pass through the top plate 26, for securing to the lift stand 20 via the nut 34/washer 38. The top plate 26 also includes an opening 40, to allow the top end 28 of the lifting rod 14 to project through the top plate 26, when the top plate 26 is secured to the lift stand 20. Further, in at least one embodiment, the top plate 26 includes one or more ribs or other projections 42 on its underside, which, in cooperation with the interior sidewalls 44 of the lift stand 20, prevent rotation/sliding of the top plate 26 when the threaded rod 14 is loaded by weight on the lifting rail 12. However, advantageously, the top plate 26 may be rotated away from the lift stand 20 when the retaining nut 34 is loosened, for easy installation or removal of the threaded rod 14.

During lifting via the lifting rail 12, the threaded rods 14 are stationary, and one sees in FIG. 3 that the bottom end 24 of each threaded rod 14 includes a projection 50 that fits into a correspondingly shaped recess or opening 52 in the base plate 22 of its respective lift stand 20. The projection 50, e.g., a square-shaped head, engages with interior walls of the recess 52, to prevent rotation of the threaded rod 14. The bottom end 24 of the threaded rod 14, including the projection 50, may be integrally formed with the threaded rod 14, or may be machined or otherwise manufactured as a separate piece that is joined or otherwise attached to the threaded rod 14. In one embodiment, the bottom end 24 of the threaded rod 14 is a machined part that is press-fitted to one end of the threaded rod 14 (e.g., an “all-thread” rod). Note that the other end of the threaded rod 14, i.e., the top end 28, may be formed by machining, or may be formed by joining a separate top piece to the top end of the threaded rod 14.

In any case, with the threaded rods 14 fixed against rotation during lifting operations, it will be understood that the threaded rods are stationary during lifting, and that the lifting rail 12 “rides” up and down on the threaded rods 14 via the spindle assemblies 18. As noted, one spindle assembly 18 is fixed within each end 16 of the lifting rail 12. FIG. 3 provides a cut-away view of one of the spindle assemblies 18.

In at least one embodiment, one spindle 18 is driven by an external motor, such as an electric drill, and the spindle 18 shown in cutaway view in FIG. 3 includes a drive input 60, which may comprise a fixed bolt head or other mechanical interface of standard shape and size that can be engaged via a standard electric drill driver. Turning the drive input 60 correspondingly turns a worm 62 that engages a worm gear 64, which comprises a fixed element within the spindle assembly 18. Thus, turning the worm 62 turns the worm gear 64 and correspondingly causes the spindle assembly 18 to rotate. Note that the worm gear 64 may be keyed, as may be other items in the “stack” comprising the spindle assembly 18, to lock the worm gear 64 into place, such that rotating the worm 62 necessarily causes rotation of the overall spindle assembly 18.

The spindle assembly 18 also carries a sprocket 66, which is spaced apart from the worm gear 64 via one or more spacers 68. The sprocket 66 engages a sprocket chain 70, which is carried within the interior of the lifting rail 12 and interconnects to a like sprocket 66 of the spindle assembly 18 at the other end 16 of the lifting rail 12. Other interconnection arrangements are contemplated herein, such as the use of a belt to interconnect the two spindle assemblies 18, in which case each spindle assembly 18 includes a belt pulley in place of the sprocket 66. As a further alternative, a worm gear running the length of the lifting rail 12 can be used to interconnect the two spindle assemblies 18 together.

With all such arrangements, the spindle assembly 18 shown in cutaway view is driven by an external motive force provided at its drive input 60 and acts as the “master spindle assembly,” while the second spindle assembly 18 at the other end 16 of the lifting rail 12 is indirectly driven via the sprocket chain 70, and therefore operates as a “slave spindle assembly.” It will be understood that this arrangement locks rotation of the slave spindle assembly 18 to the master spindle assembly 18, such that both spindle assemblies 18 move up the threaded rods 14 in synchronization when the drive input 60 is turned in one direction, and likewise move down the threaded rods 14 in synchronization when the drive input 60 is turned in the other direction.

As a further alternative, a drive motor, e.g., a DC motor, is incorporated into the lifting apparatus 10, e.g., at the “master spindle assembly” end of the lifting rail 12, and on/off and up/down controls are provided via a user interface. Still further, to eliminate the secondary drive connection carried within the lifting rail 12, e.g., the sprocket chain or belt, each spindle assembly 18 can be provided with its own motor and operation of the two motors can be locked together via motor control circuitry. In such embodiments, the contemplated motor control circuitry may include closed-loop speed control for the two motors, to ensure that they operate at the same speed, to maintain the lifting rail 12 in a level position at it moves up or down along the threaded rods 14.

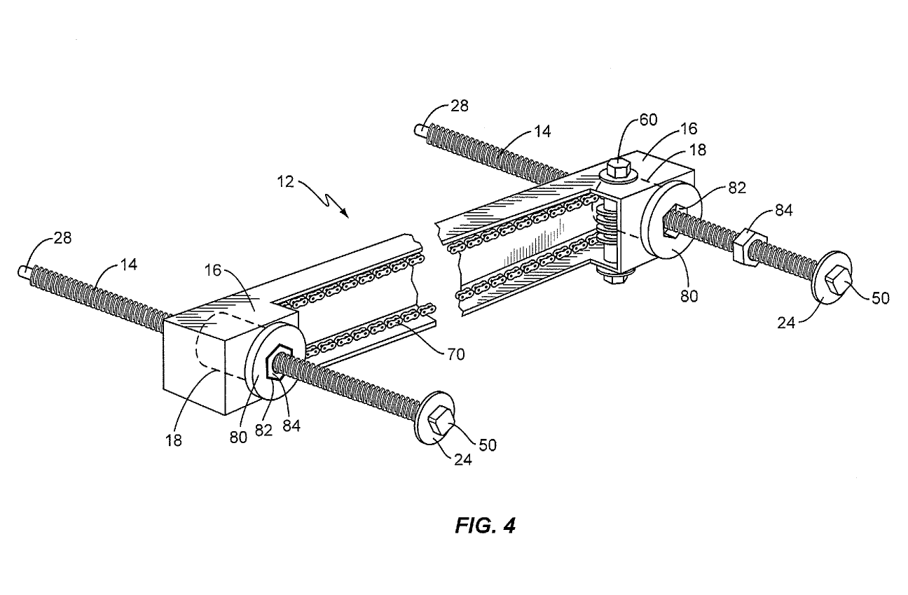

It should be appreciated that, regardless of the drive implementation details, rotation of the spindle assemblies 18 causes them to move either up or down on the respective threaded rods 14, depending upon the direction of rotation. To better understand this operation, FIG. 4 illustrates a perspective view, showing the bottom of the lifting rail 12. From this perspective, one sees the sprocket chain 70 carried within the interior of the lifting rail 12, whose bottom side may be open, except at the boxed ends 16. More particularly, however, one sees that the bottom of each spindle assembly 18 includes a thrust bearing 80, which includes a recess 82 configured to receive a hex nut 84 (or to receive another shape of threaded element that is threaded onto the threaded rod 14 on which the spindle assembly 18 is mounted).

This configuration permits the spindle assembly 18 to be freely slid along the threaded rod 14 until it engages the hex nut 84, i.e., until the hex nut 84 is seated into the recess 82 on the bottom side of the spindle assembly 18. By capturing the hex nut 84 in this correspondingly shaped bottom recess 82, rotating the spindle assembly 18 correspondingly rotates the hex nut 84, meaning that rotation of the spindle assembly 18 moves it up or down along the threaded rod 14, while still allowing the spindle assembly 18 to be easily slipped onto and off of the threaded rod 14, for easy assembly/disassembly and for easy lifting setup.

It should be understood that in a preferred embodiment, each spindle assembly 18 includes a smooth interior bore through which one of the threaded rods 14 is inserted. Preferably, the interior diameter of this inner bore is only slightly larger than the outer diameter of the threaded rod 14, to prevent side-to-side movement of the spindle assembly 1 8 when mounted on the threaded rod 14. Thus, in preparation for a lifting operation, a user simply positions the hex nuts 84 at similar positions on the two threaded rods 14, so that the lifting rail 12 drops onto the hex nuts in a level orientation.

Given the free movement of the lifting rail 12 along the threaded rods 14, the user can easily adjust height of the hex nuts 84, to fine tune leveling of the lifting rail 12. The close tolerance between the outer diameter of the lifting rod 14 and the inner diameter of the spindle assembly's inner bore is also advantageous in that it results in binding of the lifting rail 12 on the threaded rods 14, if one end 16 of the lifting rail 12 becomes unleveled.

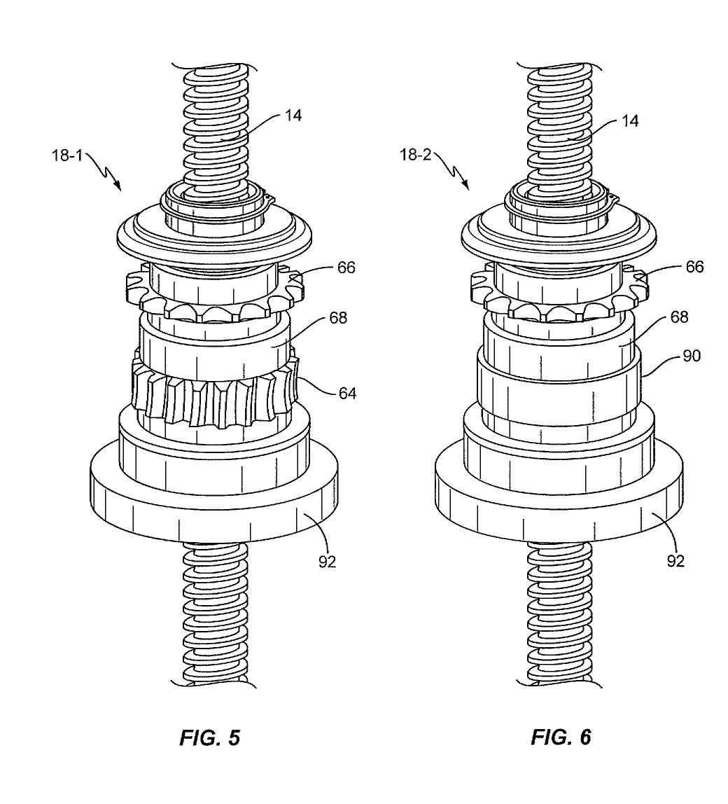

One embodiment of the master/slave spindle assembly arrangement is shown in more detail in FIGS. 5 and 6, where FIG. 5 illustrates the master spindle assembly configuration and FIG. 6 illustrates the slave spindle assembly configuration. For clarity of reference, the spindle assembly is referred to in FIG. 5 as 18-1, and in FIG. 6 as 18-2, to differentiate between the master and slave configurations.

From the two figures, one sees that the master and slave configurations are essentially identical, except that the spindle assembly 18-2 omits the worm gear 64, as it is not driven by a worm 62, but rather driven by the spindle assembly 18-1 via the sprocket 66 and sprocket chain 70. In place of the worm gear 64, the spindle assembly 18-2 includes a spacer 90, which may be a gear blank or a DELRIN disc spacer, for example. Preferably, the spacer 90 is the same height as the worm gear 64, such that vertical positions of various elements in the stack of components comprising the spindle assembly 18-2 correspond directly to like elements in the spindle assembly 18-1.

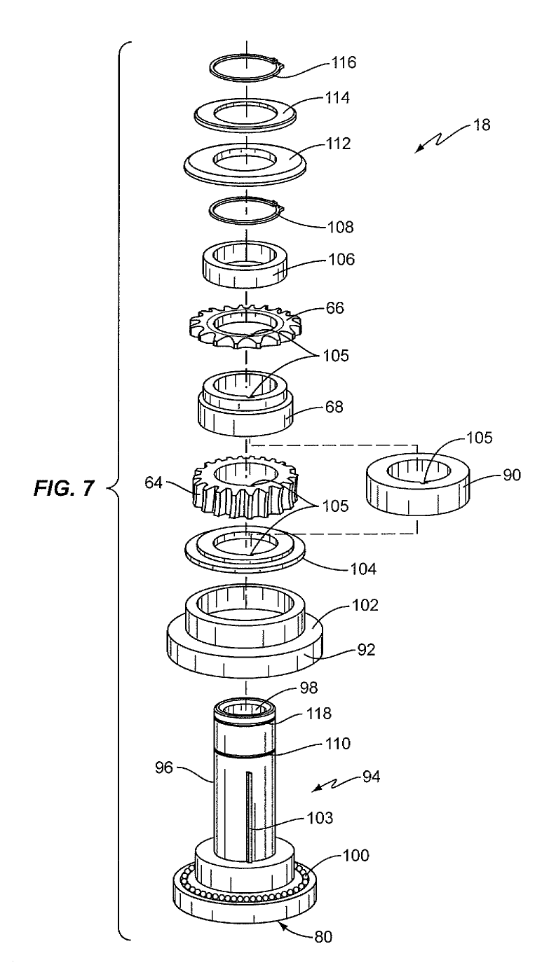

Regarding this stacking of components to make up one spindle assembly 18, one sees that a thrust bearing cap 92 rides on the thrust bearing 80, which was introduced in FIG. 4, but is not visible in FIG. 5 or 6. The interplay between the thrust bearing cap 92 and the thrust bearing 80 is more easily understood with reference to the exploded view provided by FIG. 7.

One sees that the spindle assembly 18 comprises a carrier 94, which may be integrally machined, or formed from two or more pieces fitted together. The bottom end of the carrier 94 includes or otherwise forms the thrust bearing 80 illustrated earlier, and thus rests on and engages the hex nut 84 on the threaded rod 14. One also sees that the carrier 94 includes an inner bore 98, and that an extended cylindrical section 96 of the carrier 94 acts as the carrier for vertically stacking the various components that form the spindle assembly 18.

First in the stack, in order of assembly, is the thrust bearing cap 92, first introduced in FIGS. 5 and 6. The thrust bearing 80 includes a radiused perimeter groove on its upper surface, in which a number of ball bearings 100 rest. The thrust bearing cap 92 is thus placed onto the stack such that it rotatably “rides” on the thrust bearing 80. The use of precision ball bearings 100, or other free-spinning bearing arrangements, allows the thrust bearing cap 92 to remain stationary, while permitting the carrier 94 to rotate. This arrangement allows an upper surface lip 102 of the thrust bearing cap 92 to rest against the bottom face of the lifting rail 12 (at one end 16 of the lifting rail 12), while still allowing the carrier 94 to rotate around the threaded rod 14.

Note that the cylindrical section 96 of the carrier 94 may include a vertical key 103, and select components in the stack may be correspondingly keyed (grooved) to match the key 103, while other components are not keyed. For example, the worm gear 64 is keyed (slot 105), so that it is locked to the carrier 94, meaning that turning the worm gear 64 turns the carrier 94. Likewise, the sprocket 66 is keyed (slot 105), thus locking it to the carrier 94 and forcing it to rotate with rotation of the carrier 94. On the other hand, the thrust bearing cap 92 is not keyed to carrier 94, meaning that it can remain in a static, non-rotating position as the carrier 94 rotates.

Washers 104 or other spacers are used to space/retain the thrust bearing cap 92 from the worm gear 64, and the previously mentioned spacer 68 (or spacers) is used to space the worm gear 64 from the sprocket 66. (Note that slave spindle stack configurations use gear blank or spacer 90 in place of the worm gear 66.) A further spacer 106 may be used to space a snap ring 108 from the sprocket 66. The snap ring 108 snaps into a circumferential groove 110 formed in the carrier 94, and thus locks the stack elements below it into place.

The cylindrical section 96 of the carrier 94 is long enough to project through the top wall or plate at the end 16 of the lifting rail 12, and the remaining stack elements are positioned on the top-side of the lifting rail. Particularly, a flanged bushing 1 12 is placed onto the cylindrical section 96 on the top-side of the lifting rail 12, for contacting the top surface of the lifting rail 12. A topside washer 114 is placed onto the cylindrical section 96, to position it above the flanged bushing 112, and the topmost snap ring 116 is snapped onto the cylindrical section 96. In at least one embodiment, the cylindrical section 96 of the carrier 94 includes a circumferential groove 118, for snapping the final snap ring 116 into place and thereby securing the spindle assembly 18 to the rail 12.

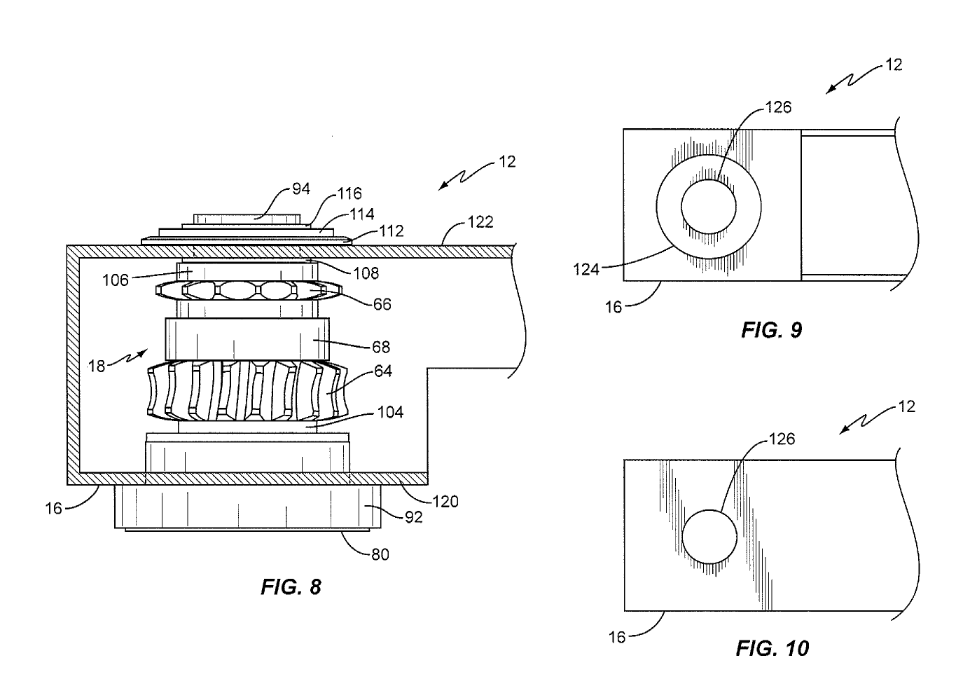

FIG. 8 illustrates a cutaway view of the spindle assembly 18 installed within a boxed end 16 of the lifting rail 12. In particular, the spindle assembly 18 projects through a bottom wall or plate 120 at the illustrated end 16 of the lifting rail 12, and similarly projects through a top wall or plate 122 at the same end 16. As noted, the flanged bushing 112, top washer 114, and top snap ring 116 are installed onto the carrier 94 on the top side of the top plate 122. With respect to this arrangement, it should be understood that all or at least a majority of the load can be supported by the circumferential lip 102 of the thrust bearing cap 92. Thus, design parameters to consider with respect to lifting capabilities include the surface area of the circumferential lip 102 and its thickness, along with the thickness or, more generally, the load bearing rating of the bottom walls 120 of the boxed ends 16 of the lifting rail 12.

Correspondingly, FIG. 9 illustrates a bottom view of one boxed end 16 of the lifting rail 12, and illustrates the bottom side hole 124 and top side hole 126, through which the spindle assembly 18 is inserted. (The spindle assembly 18 is inserted upward through the bottom side hole 124, formed in the bottom plate 120, and pushed upward until the top end of the cylindrical section 96 projects through the top side hole 126, formed in the top plate 122. The flanged bushing 112, top washer 114, and snap ring 116 are then installed onto the projecting portion of the cylindrical section 96, completing the illustrated spindle assembly embodiment. FIG. 10 provides a top view of the boxed end 16, in which the top side hole 126 is visible.

Of course, those skilled in the art will appreciate that different stacking and locking arrangements can be used, and various other implementations are contemplated herein. Advantageously, however, regardless of their implementation details, each spindle assembly 18 is configured to have a smooth interior bore, allowing it to be slid onto a threaded rod 14 and freely moved along the length of that threaded rod 14. At the same time, the bottom of each spindle assembly 18 includes a physical feature, e.g., the illustrated recess 82, which is configured to catch or otherwise engage a hex nut 84 or similar threaded object that is threaded onto the threaded rod 14.

Further, each spindle assembly 18 is configured to have one or more weight bearing surfaces, e.g., the circumferential lip 102 of the thrust bearing cap 92, which contact or otherwise engage the lifting rails, while still allowing rotation of the rest of the spindle assembly 18. By capturing the hex nut 84, that rotation also rotates the hex nut 84 and thereby moves the spindle assembly 18 either up or down the threaded rod 14, depending on the rotational direction. In this manner, each spindle assembly 18 is supported by the hex nut 84 threaded onto its respective threaded rod 14 and, in turn, each end 16 of the lifting rail 12 is supported by a respective one of the spindle assemblies 18.

By slaving rotation of the two spindle assemblies 18 together, either by mechanical connection or via electrical control, the lifting rail 12 can be moved up and down in a level, controlled fashion. Tremendous lifting force is generated by the screw action of the threaded rods 14/hex nuts 84, making the lifting apparatus 10 particularly useful in lifting heavy equipment off of pallets, thereby allowing easy and rapid pallet removal for subsequent handling of the equipment. Indeed, an advantageous lifting and pallet removal method is provided by the free “floating” arrangement of the spindle assemblies 18 and lifting rail 12.

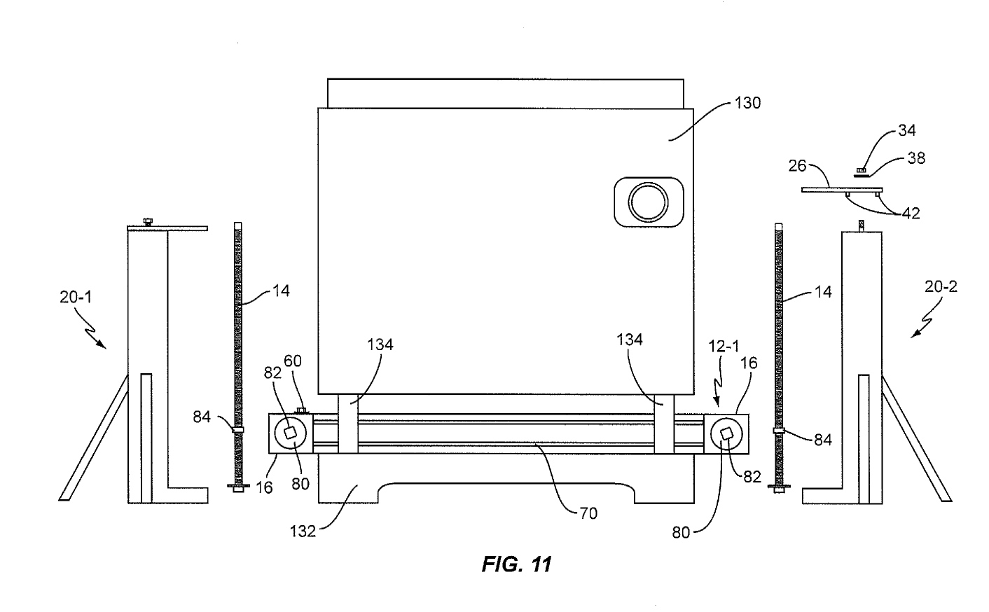

Referring to FIG. 11, one sees a potentially heavy piece of equipment 130 standing on a pallet 132. According to a lifting/pallet removal method contemplated herein, one or more lifting rails 12 are detached from their respective threaded rods and slid under the equipment 130. The illustration shows that a lifting rail 12-1 is slid under the equipment, behind its support legs 134. However, depending on the edge overhang of the equipment, there may be room to place the lifting rail 12 in front of the legs 134. Also, it will be appreciated that a pair of lifting apparatuses 10 will be used to lift the equipment 130, with lifting rails 12 positioned under opposite sides or ends of the equipment 130.

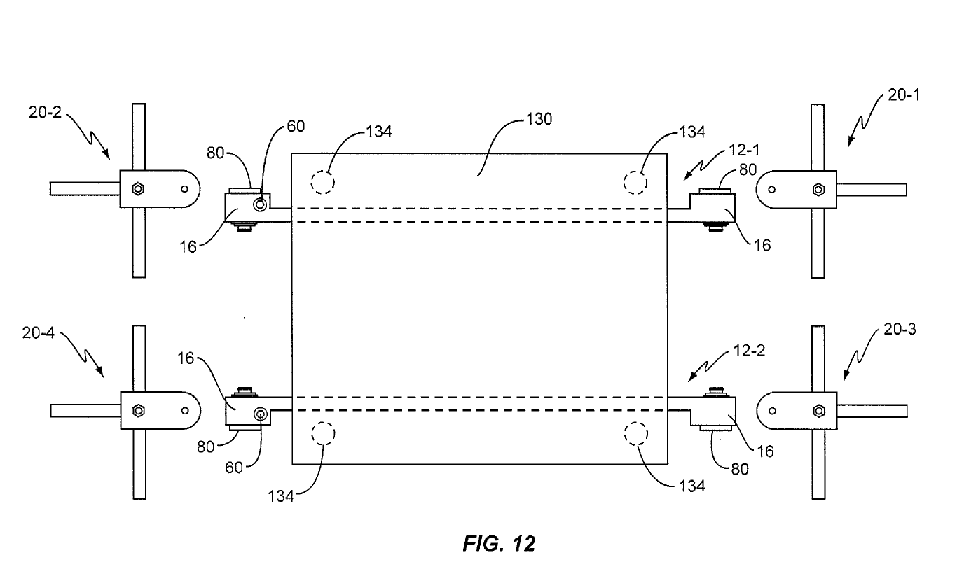

FIG. 12 depicts this arrangement more clearly, where one sees a first lifting rail 12-1 paired with lift stands 20-1 and 20-2, and a second lifting rail 12-2, paired with lift stands 20-3 and 20-4. Note that in master/slave spindle assembly configurations, it may be advantageous for the user to place the master ends of the lifting rails 12 on the same side of the equipment 130, to allow easy access to the respective drive inputs 60. (Note that for a given lifting rail 12, there may be a drive input 60 on either or both sides of the boxed end 16 that houses the master spindle assembly 18, to facilitate operator access.)

In any case, one sees that both lifting rails 12-1 and 12-2 are placed on their sides and slid under opposite ends of the equipment 130. Now turning back to FIG. 11, the lifting method continues with inserting one of the threaded rods 14 through the spindle assembly 18 at each end 16 of the lifting rail 12-1 (or 12-2). This insertion can be done while the lifting rail 12-1 (or 12-2) is still lying in its horizontal position, which means that the user need not worry about whether the pre-lift height of the lifting rails 12 is high enough to allow threaded rod insertion. Note that the hex nut 84 on each threaded rod 14 preferably is preset by the user to the desired pre-lift height, and the user preferably ensures that all the hex nuts 84 are threaded to similar positions on their respective threaded rods 14, so that the lifting rails 12 start off in a substantially level position, preferably at a desired height for beginning the lift.

Once the threaded rods 14 are inserted, the lifting rail 12-1 (or 12-2) can be turned to its vertical orientation for lifting, and the bottom ends 24 of the threaded rods 14 may be seated into the base plates 22 of their respective lift stands 20-1 and 20-2 (or 20-3 and 20-4). The top plates 26 can then be fastened or otherwise locked into place over the top ends 28 of the threaded rods 14, thereby securing the threaded rods 14 into place within the lift stands 20-1 and 20-2 (or 20-3 and 20-4) for lifting. The whole process can then be repeated from the remaining lift rail 12-2 (or 12-1) and the corresponding pair of lift stands 20-3 and 20-4 (or 20-1 and 20-2).

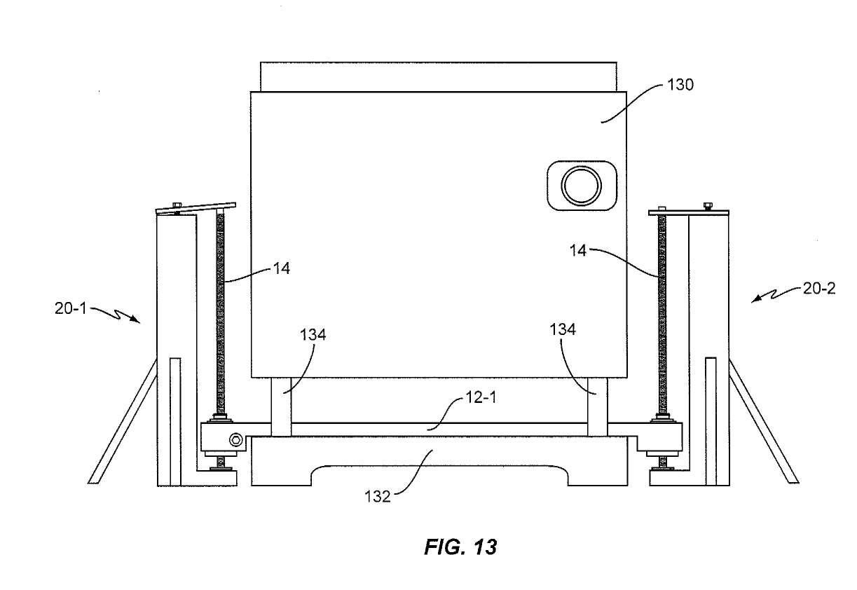

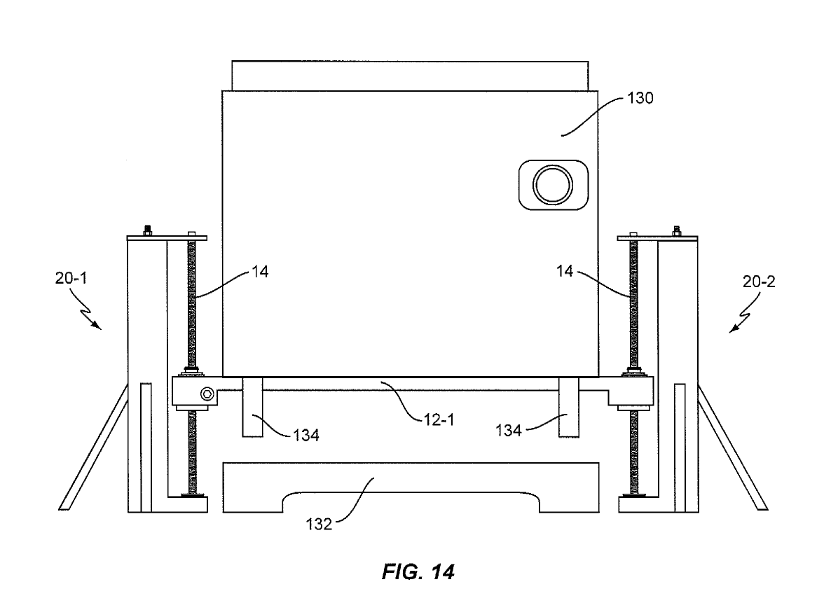

FIG. 13 illustrates lifting rail 12-1 thus installed and made ready for lifting, and the lifting rail 12-2 at the opposite end of the equipment 130 is likewise made ready. FIG. 14 shows the equipment 130 in its lifted position, where it is conveniently raised above the pallet 132. In this position, the pallet 132 can be easily slid out from underneath the equipment 130, and the equipment 130 can be lowered to rest directly on the floor/ground, dollies, or other moving equipment, or a forklift or other transport equipment can be safely and easily moved into place.

Of course, other lifting methods can be practiced, which should be understood to fall within the scope of implementation and usage variations contemplated herein for the lifting apparatus 10. For example, each lifting rail 12 may include one or more intermediate spindle assemblies 18, fixed at positions between the ends 16. Each such intermediate spindle assembly 18 provides an additional lifting point, i.e., a threaded rod 14 can be inserted through the intermediate spindle assembly 18 and placed into a respective lift stand 20. The sprocket chain 70 or other interconnecting drive mechanism can be used to drive all such intermediate spindle assemblies 18. These additional lifting points provide greater lifting capability by providing additional lifting support between the ends 16 of the lifting rail 12.

With these and other variations in mind, those skilled in the art will appreciate that the present invention is not limited to the foregoing discussion and accompanying drawings. Instead, the present invention is limited only by the claims and their legal equivalents.

What is claimed is:

1. A lifting apparatus comprising:
first and second lift stands, each lift stand configured to support a threaded rod in a vertical orientation and prevent its rotation during operation of the lifting apparatus;
a lifting rail configured to have a respective one of the threaded rods inserted through each of its ends, wherein each end of the lifting rail incorporates a rotatably mounted spindle assembly through which the respective threaded rod is inserted, each spindle assembly configured to ride up or down on the respective threaded rod, in dependence on which direction the spindle assembly is rotated; and
said lifting rail including a spindle drive configured to rotate the spindle assemblies and to slave rotation of a second one of the second spindle assemblies to that of a first one of the spindle assemblies.

2. The lifting apparatus of claim 1, wherein each spindle assembly is configured to ride up or down on the respective threaded rod by including a bottom recess that is configured to rest upon and capture a threaded nut installed on the respective threaded rod, such that rotating the spindle assembly rotates the threaded nut on the respective threaded rod.

3. The lifting apparatus of claim 2, wherein each spindle assembly includes a carrier having an extended cylindrical section that defines a non-threaded interior bore through which the respective threaded rod freely slides.

4. The lifting apparatus of claim 3, wherein the carrier includes a thrust bearing forming a bottom of the spindle assembly, said thrust bearing including a bottom surface that includes the recess for capturing the threaded nut and a top surface that carries a plurality of ball bearings, and wherein the spindle assembly further includes a thrust bearing cap that is configured to be installed onto the carrier and ride on the plurality of ball bearings, such that the carrier remains rotatable relative to the thrust bearing cap and the thrust bearing cap provides a non-rotating, load-bearing surface fixed against a bottom surface of the lifting rail.

5. The lifting apparatus of claim 3, wherein a top of the carrier projects through a top surface at the respective end of the lifting rail and includes a groove or other mechanical feature for retaining a snap ring that retains the spindle assembly within the respective end of the lifting rail.

6. The lifting apparatus of claim 1, wherein the spindle drive comprises a rotatable drive input configured for engagement by an external driver that provides motive force for rotating the spindle assemblies, said drive input mechanically coupled to the first spindle assembly, such that rotating the drive input rotates the first spindle assembly, and said second spindle assembly mechanically coupled to the first spindle assembly, such that rotating the first spindle assembly correspondingly rotates the second spindle assembly.

7. The lifting apparatus of claim 6, wherein the first spindle assembly includes a gear driven by a worm gear that is rotated by rotation of the drive input, and further includes a sprocket or belt pulley that is mechanically coupled by a chain or belt within the lift rail to a like sprocket or belt pulley included on the second spindle assembly.

8. The lifting apparatus of claim 6, wherein the first spindle assembly includes a first gear driven by a first worm gear that is rotated by rotation of the drive input, and further includes a second gear that drives a second worm gear, and wherein the second spindle assembly includes a third gear driven by the second worm gear.

9. The lifting apparatus of claim 6, wherein the drive input includes a bolt head configured for engagement via an electric drill.

10. The lifting apparatus of claim 1, wherein the lifting apparatus includes a first electric motor configured to provide motive force for rotating the first spindle assembly, and wherein the lifting rail further includes a mechanical linkage between the first and second spindle assemblies, for slaving rotation of the second spindle assembly to that of the first spindle assembly.

11. The lifting apparatus of claim 10, wherein the mechanical linkage comprises one of a chain, belt, or worm gear, configured to slave rotation of the second spindle assembly to that of the first spindle assembly.

12. The lifting apparatus of claim 1, wherein the lifting apparatus includes a first electric motor configured to provide motive force for rotating the first spindle assembly, a second electric motor to provide motive force for rotating the second spindle assembly, and a control connection between the first and second motors to slave operation of the second motor to that of the first motor.

13. The lifting apparatus of claim 12, wherein the lifting apparatus further includes a control interface, for an operator to control turning the first and second motors on and off, and controlling motor direction.

14. The lifting apparatus of claim 1, wherein each lift stand is configured to support a respective one of the threaded rods in a vertical orientation by including a base plate configured to retain and support a bottom end of the threaded rod, and a top plate configured to retain a top end of the thread rod, said top plate configured to disengage from the respective threaded rod, to thereby allow installation and removal of the respective threaded rod from the lifting stand.

15. The lifting apparatus of claim 1, further wherein the lifting rail includes at least one more spindle assembly positioned between the ends of the lifting rail, to provide an additional load-bearing lift point for the lifting rail, and further comprising a like number of threaded rods to be inserted through the at least one more spindle assembly, and a like number of lifting stands to support the like number of threaded rods, and wherein rotation of the at least one more spindle assembly is slaved to rotation of the first spindle assembly.

16. A method of lifting a load comprising:
positioning first and second lifting rails under opposing sides of an item of equipment to be lifted, each said lifting rail having a rotatable spindle assembly incorporated into each end, and each said spindle assembly configured to ride up or down on a vertically-oriented threaded rod, in dependence on which direction the spindle assembly is rotated;
inserting a threaded rod through each spindle assembly until a threaded nut installed thereon engages with a recess included in a bottom surface of each spindle assembly, said recess configured to capture the threaded nut so that the threaded nut is rotated by rotation of the spindle;
seating each threaded rod in a respective lift stand, that is configured to retain top and bottom ends of the-threaded rod and to support the threaded rod in a vertical position, such that the spindle assembly through which the threaded rod is inserted rests on the threaded nut; and
rotating the spindle assemblies together, at least as regards the spindle assemblies included within each lifting rail, such that the respective ends of each lifting rail move up or down together.

17. A lifting apparatus comprising a lifting rail that is supported at each end by a threaded rod that is vertically retained by a lift stand and inserted through a rotatably-mounted spindle assembly incorporated into the end of the lifting rail, wherein each said spindle assembly is configured to rest on and engage a threaded nut installed on the threaded rod, such that rotation of the spindle assembly rotates the threaded nut and thereby moves the spindle assembly up or down along the threaded rod, in dependence on the direction of rotation, and further wherein the lifting rail includes a spindle drive that is configured to slave rotation of the spindle assemblies together, for maintaining a level orientation of the lifting rail as it is raised or lowered on the threaded rods via rotation of the spindle assemblies.

18. The lifting apparatus of claim 17, wherein the spindle drive comprises one or more electric motors configured to rotate the spindle assemblies, for raising or lowering the lifting rail.

19. The lifting apparatus of claim 17, wherein the spindle drive comprises a mechanical drive input that is rotatable via an external driver, said mechanical drive input configured to rotate a first one of the spindle assemblies, and wherein the lifting rail includes a mechanical linkage that interconnects a second one of the spindle assemblies with the first spindle assembly, to thereby slave rotation of the second spindle assembly with that of the first spindle assembly.

20. The lifting apparatus of claim 17, wherein each lifting stand includes a base plate for retaining a bottom end of the lifting rod installed therein, and a top plate for retaining a top end of the lifting rod, said top plate configured to disengage from the top end of the threaded rod, to permit installation and removal of the threaded rod.
